(19) United States
(12) Patent Application Publication
(10) Pub. No.: US 2012/0200150 A1
(43) Pub. Date: Aug. 9, 2012

(54) WIRELESS POWER TRANSMISSION SYSTEM

(75) Inventor: Takashi URANO, Tokyo (JP)

(73) Assignee: TDK Corporation

(21) Appl. No.: 13/288,839

(22) Filed: Nov. 3, 2011

Related U.S. Application Data
(60) Provisional application No. 61/440,605, filed on Feb. 8, 2011.

(51) Int. Cl. B60L 1/00; H01F 38/14

(52) U.S. Cl. 307/9.1; 307/104

(57) ABSTRACT

A wireless power transmission system aims to feed power by wireless from a feeding coil to a receiving coil using a magnetic field resonance phenomenon between the feeding coil and receiving coil. The wireless power transmission system includes the feeding coil, receiving coil, a loading coil, and a power transmission control circuit. The power transmission control circuit supplies AC power to the feeding coil so as to make the feeding coil feed the AC power to the receiving coil. The loading coil is magnetically coupled to the receiving coil to receive the AC power from the receiving coil. A light control glass receives the AC power from the loading coil. The transparency of the light control glass is changed by the AC power received by the loading coil.

### BACKGROUND OF THE INVENTION

1. Field of the Invention

The present invention relates to wireless power feeding and, more particularly, to its application to living space.

2. Description of Related Art

A wireless power feeding technique of feeding power without a power cord is now attracting attention. The current wireless power feeding technique is roughly divided into three: (A) type utilizing electromagnetic induction (for short range); (B) type utilizing radio wave (for long range); and (C) type utilizing resonance phenomenon of magnetic field (for intermediate range).

The type (A) utilizing electromagnetic induction has generally been employed in familiar home appliances such as an electric shaver; however, it can be effective only in a short range. The type (B) utilizing radio wave is available in a long range; however, it has small electric power. The type (C) utilizing resonance phenomenon is a comparatively new technique and is of particular interest because of its high power transmission efficiency even in an intermediate range of about several meters. For example, a plan is being studied in which a receiving coil is buried in a lower portion of an EV (Electric Vehicle) so as to feed power from a feeding coil in the ground in a non-contact manner. Hereinafter, the type (C) is referred to as “magnetic field resonance type”.

The magnetic field resonance type is based on a theory published by Massachusetts Institute of Technology in 2006 (refer to Patent Document 1). In Patent Document 1, four coils are prepared. The four coils are referred to as “exciting coil”, “feeding coil”, “receiving coil”, and “loading coil” in the order starting from the feeding side. The exciting coil and feeding coil closely face each other for electromagnetic coupling. Similarly, the receiving coil and loading coil closely face each other for electromagnetic coupling. The distance (intermediate distance) between the feeding coil and receiving coil is larger than the distance between the exciting coil and feeding coil and distance between the receiving coil and loading coil. This system aims to feed power from the feeding coil to receiving coil.

When AC power is fed to the exciting coil, current also flows in the feeding coil according to the principle of electromagnetic induction. When the feeding coil generates a magnetic field to cause the feeding coil and receiving coil to magnetically resonate, high current flows in the receiving coil. At this time, current also flows in the loading coil according to the principle of electromagnetic induction, and power is taken from a load connected in series to the loading coil. By utilizing the magnetic field resonance phenomenon, high power transmission efficiency can be achieved even if the feeding coil and receiving coil are largely spaced from each other.

### CITATION LIST

### Patent Document

[Patent Document 1] U.S. Pat. Appln. Publication No. 2008/0278264
[Patent Document 2] Jpn. Pat. Appln. Laid-Open Publication No. 2006-230032
[Patent Document 3] International Publication No. WO2006-022365
[Patent Document 4] U.S. Patent Application Publication No. 2009-0072629
[Patent Document 5] Jpn. Pat. Appln. Laid-Open Publication No. 2006-74848
[Patent Document 6] Jpn. Pat. Appln. Laid-Open Publication No. H07-4079
[Patent Document 7] Jpn. Pat. Appln. Laid-Open Publication No. H06-95169
[Patent Document 8] Jpn. Pat. Appln. Laid-Open Publication No. H05-287969

Patent Documents 6 and 7 (Jpn. Pat. Appln. Laid-Open Publications No. H07-4079 and No. H06-95169 are documents about a light control glass (switched privacy glass). The transparency of the light control glass changes due to current application. However, in the case where an installation method of a light control glass like Patent Document 6 or 7 is employed, in-wall wiring work needs to be done. Further, operation failure easily occurs due to accumulation of dirt in a contact portion. Patent Document 8 (Jpn. Pat. Appln. Laid-Open Publication No. H05-287969) does not relate directly to the light control glass but discloses a technique that supplies power from a door frame to an automatic door through a transformer (type (A) utilizing electromagnetic induction). Although the door frame and automatic door do not contact each other, wiring need to be brought up to near the transformer. The present inventor considered that such a problem could be solved by wireless power feeding of a magnetic resonance type.

### SUMMARY

The wireless power feeding of a magnetic resonance type is still in the research stage, so that not many practical applications thereof have been proposed so far. An object of the present invention is to propose an application method of the wireless power feeding of a magnetic resonance type to living space.

A wireless power transmission system according to the present invention feeds power by wireless from a feeding coil to a receiving coil using a magnetic field resonance phenomenon between the feeding coil and receiving coil. The system includes: the feeding coil; the receiving coil; a power transmission control circuit that supplies AC power to the feeding coil so as to make the feeding coil feed the AC power to the receiving coil; a loading coil that is magnetically coupled to the receiving coil to receive the AC power from the receiving coil; and a light control glass that receives the AC power from the loading coil. The transparency of the light control glass is changed by the AC power received by the loading coil.

The transparency of the light control glass is controlled by wireless power feeding, so that it is easy to simplify the wiring structure. Further, in the case of a magnetic resonance type, the feeding coil and receiving coil need not face each other with a small distance, the installation position of the light control glass is less restrained by the position of the feeding coil.

Both the feeding coil and receiving coil may be installed in the inner wall of a building. For example, the feeding coil may be installed in the ceiling of the building, and the receiving coil may be installed in the side wall of the building.

The receiving coil and loading coil may be installed so as to surround the light control glass. The larger the coil area, the easier the receiving coil or loading coil can receive AC power. By installing these coils so as to surround the light control glass, a sufficient coil area can be ensured. Further, by integrating the receiving coil or loading coil with the glass frame (the frame part of the glass area) of the light control glass, it is possible to prevent the visual appearance from being impaired.

The feeding coil may be installed in the inner wall of a vehicle, and the light control glass may be fit in a vehicle window. According to such a configuration, the transparency of the window of a vehicle can be controlled by wireless power feeding. The receiving coil and loading coil may be installed in the window frame of the vehicle.

The wireless power transmission system may further include a light sensor for measuring the brightness of a room. The power transmission control circuit may supply AC power to the feeding coil when the light amount detected by the light sensor is not greater than a predetermined threshold to make the light control glass transparent. According to such a configuration, the light control glass is made transparent when the brightness of a room is low, thereby allowing the outside light to be aggressively introduced. Alternatively, the light control glass may be made opaque in this case.

The wireless power transmission system may further include a human sensing sensor. The power transmission control circuit may stop supplying AC power to the feeding coil when the human sensing sensor reacts to make the light control glass opaque. According to such a configuration, the light control glass can be made opaque only when someone exists, whereby the privacy can be protected.

A plurality of the receiving coils may be provided corresponding to a plurality of light control glasses, respectively, and power may be collectively fed from the one feeding coil to the plurality of receiving coils.

The light control glass may be installed as an outer wall of an elevator. The inductance of the feeding coil may temporarily be changed by a magnetic body installed in a part of a hoistway (shaft) of the elevator. The power transmission efficiency is changed in accordance with the position of the elevator, allowing the transparency of the light control glass to be controlled in accordance with the position of the elevator.

A wireless power transmission system feeds power by wireless from a feeding coil to a receiving coil using a magnetic field resonance phenomenon between the feeding coil and receiving coil. The system includes: the feeding coil; the receiving coil; a power transmission control circuit that supplies AC power to the feeding coil so as to make the feeding coil feed the AC power to the receiving coil; a loading coil that is magnetically coupled to the receiving coil to receive the AC power from the receiving coil; and an electric lock that receives the AC power from the loading coil. The electric lock is activated or released by the AC power received by the loading coil.

A wireless power transmission system feeds power by wireless from a feeding coil to a receiving coil using a magnetic field resonance phenomenon between the feeding coil and receiving coil. The system includes: the feeding coil installed as apart of a building; the receiving coil installed as apart of the building; a power transmission control circuit that supplies AC power to the feeding coil so as to make the feeding coil feed the AC power to the receiving coil; a loading coil that is magnetically coupled to the receiving coil to receive the AC power from the receiving coil; and a lighting apparatus that receives the AC power from the loading coil. The lighting apparatus is turned ON by the AC power received by the loading coil.

It is to be noted that any arbitrary combination of the above-described structural components and expressions changed between a method, an apparatus, a system, etc. are all effective as and encompassed by the present embodiments.

According to the present invention, the advantages of wireless power feeding of a magnetic resonance type can be made to lead to improvement of convenience of everyday life.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a view illustrating operation principle of a wireless power transmission system according to a first embodiment;

FIG. 2 is a view schematically illustrating a case where the wireless power transmission system is applied to a bathroom;

FIG. 3 is a view schematically illustrating a case where the wireless power transmission system is applied to a showcase;

FIG. 4 is a view schematically illustrating a state of a light control glass when current is not applied;

FIG. 5 is a view schematically illustrating a state of the light control glass when current is applied;

FIG. 6 is a view schematically illustrating a magnetic field generated between a feeding coil and a receiving coil;

FIG. 7 is a configuration view of the wireless power transmission system according to the first embodiment;

FIG. 8 is a graph illustrating the relationship between the impedance of a power receiving LC resonance circuit and a drive frequency;

FIG. 9 is a graph illustrating the relationship between phase difference indicating voltage and drive frequency;

FIG. 10 is a view schematically illustrating a case where the wireless power transmission system is applied to an electric lock, an interior light, and the like;

FIG. 11 is a view illustrating the outer appearance of a curved light control glass including a wireless power receiver;

FIG. 12 is a view schematically illustrating a case where the wireless power transmission system is applied to a vehicle;

FIG. 13 is a view schematically illustrating a case where the transparency of a skylight is controlled by the wireless power transmission system;

FIG. 14 is a view schematically illustrating a case where the transparency of a restroom door is controlled by the wireless power transmission system;

FIG. 15 is a view schematically illustrating the transparency of an elevator window is controlled by the wireless power transmission system;

FIG. 16 is a view illustrating operation principle of the wireless power transmission system according to a second embodiment; and

FIG. 17 is a configuration view of the wireless power transmission system according to the second embodiment.

### DETAILED DESCRIPTION OF THE EMBODIMENTS

Preferred embodiment of the present invention will be described with reference to the accompanying drawings.

### First Embodiment

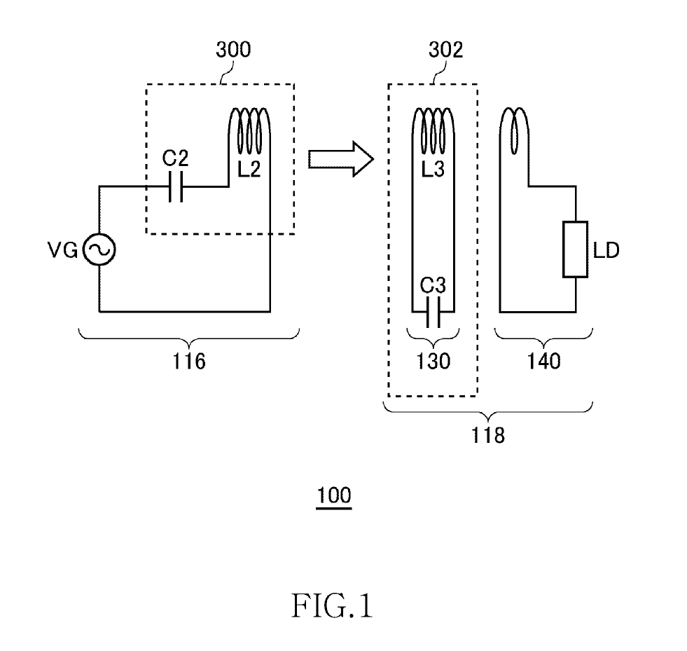

FIG. 1 is a view illustrating operation principle of a wireless power transmission system 100 according to the first embodiment. The wireless power transmission system 100 in the first embodiment includes a wireless power feeder 116 and a wireless power receiver 118. The wireless power feeder 116 includes a power feeding LC resonance circuit 300. The wireless power receiver 118 includes a receiving coil circuit 130 and a loading circuit 140. A power receiving LC resonance circuit 302 is formed by the receiving coil circuit 130.

The power feeding LC resonance circuit 300 includes a capacitor C2 and a feeding coil L2. The power receiving LC resonance circuit 302 includes a capacitor C3 and a receiving coil L3. The values of the capacitor C2, feeding coil L2, capacitor C3, and receiving coil L3 are set such that the resonance frequencies of the feeding LC resonance circuit 300 and receiving LC resonance circuit 302 coincide with each other in a state where the feeding coil L2 and receiving coil L3 are disposed away from each other far enough to ignore the magnetic field coupling therebetween. This common resonance frequency is assumed to be fr0.

In a state where the feeding coil L2 and receiving coil L3 are brought close to each other in such a degree that they can be magnetic-field-coupled to each other, a new resonance circuit is formed by the power feeding LC resonance circuit 300, power receiving LC resonance circuit 302, and mutual inductance generated between them. The new resonance circuit has two resonance frequencies fr1 and fr2 (fr1<fr0<fr2) due to the influence of the mutual inductance. When the wireless power feeder 116 supplies AC power from a power feeding source VG to the power feeding LC resonance circuit 300 at the resonance frequency fr1, the power feeding LC resonance circuit 300 constituting apart of the new resonance circuit resonates at a resonance point 1 (resonance frequency fr1). When the power feeding LC resonance circuit 300 resonates, the feeding coil L2 generates an AC magnetic field of the resonance frequency fr1. The power receiving LC resonance circuit 302 constituting apart of the new resonance circuit also resonates by receiving the AC magnetic field. When the power feeding LC resonance circuit 300 and power receiving LC resonance circuit 302 resonate at the same resonance frequency fr1, wireless power feeding from the feeding coil L2 to receiving coil L3 is performed with the maximum power transmission efficiency. Received power is taken from a load LD of the wireless power receiver 118 as output power. Note that the new resonance circuit can resonate not only at the resonance point 1 (resonance frequency fr1) but also at a resonance point 2 (resonance frequency fr2).

Although FIG. 1 illustrates a configuration in which the wireless power feeder 116 does not include an exciting coil L1, the basic operation principle is the same as in the case where the wireless power feeder 116 includes the exciting coil L1.

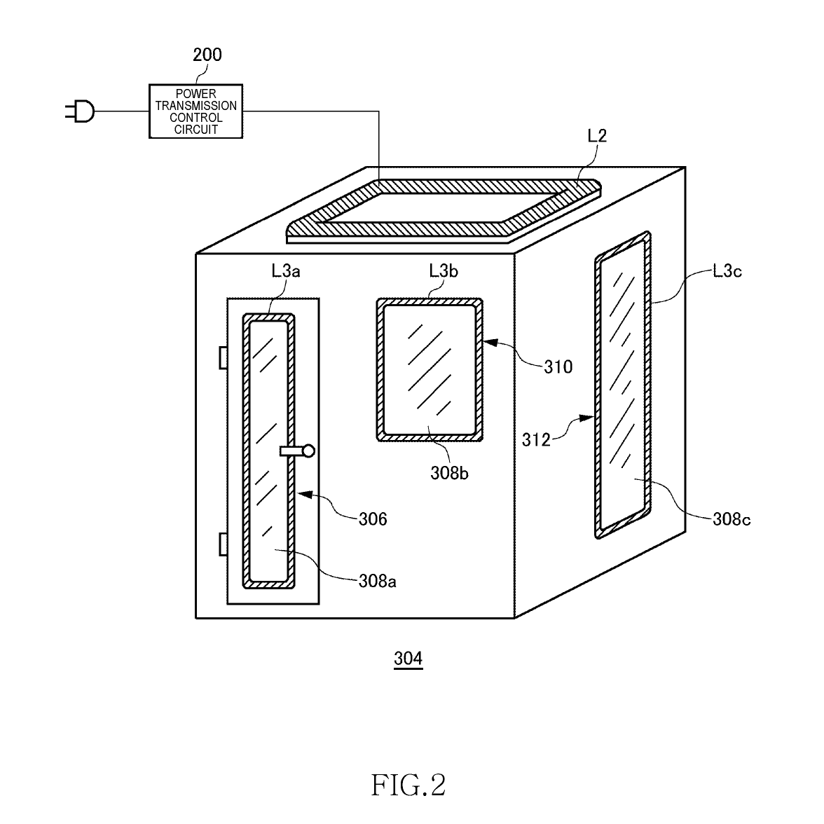

FIG. 2 is a view schematically illustrating a case where the wireless power transmission system 100 is applied to a bathroom 304. The feeding coil L2 is fitted in the ceiling of the bathroom 304. AC power is supplied to the feeding coil L2 at the resonance frequency fr1 from a power transmission control circuit 200. Thus, the feeding coil L2 generates an AC magnetic field of the resonance frequency fr1 inside the bathroom 304. That is, the wireless power feeder 116 is installed in the bathroom 304.

The side wall of the bathroom 304 has one bathroom door 306 and two windows 310 and 312, and light control glasses 308a to 308c are fitted in the bathroom door 306 and windows 310, 312, respectively. Further, receiving coils L3a to L3c are installed so as to surround the light control glasses 308a to 308c. Although not illustrated, a loading coil is installed outside the receiving coil L3, and the receiving coil L3 and loading coil are strongly magnetically coupled to each other. The loading coil is connected to the light control glass 308 by wire. That is, the wireless power receiver 118 is also installed in the bathroom 304.

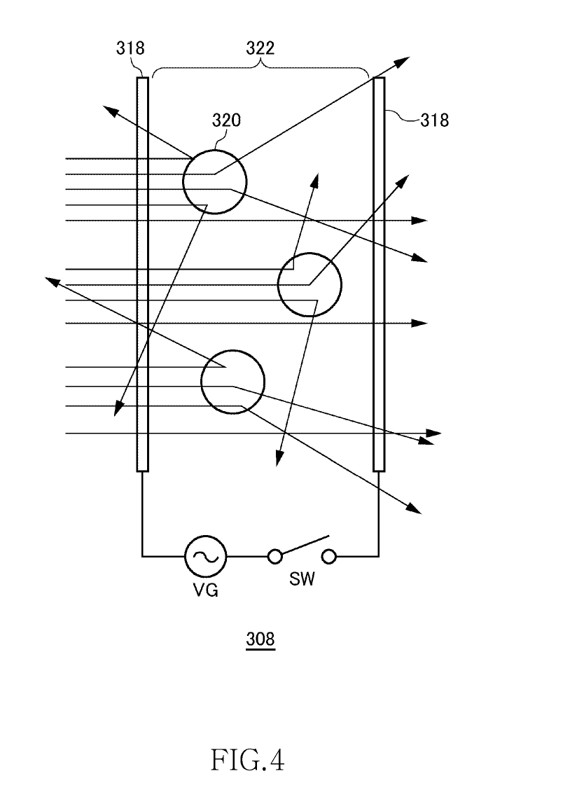

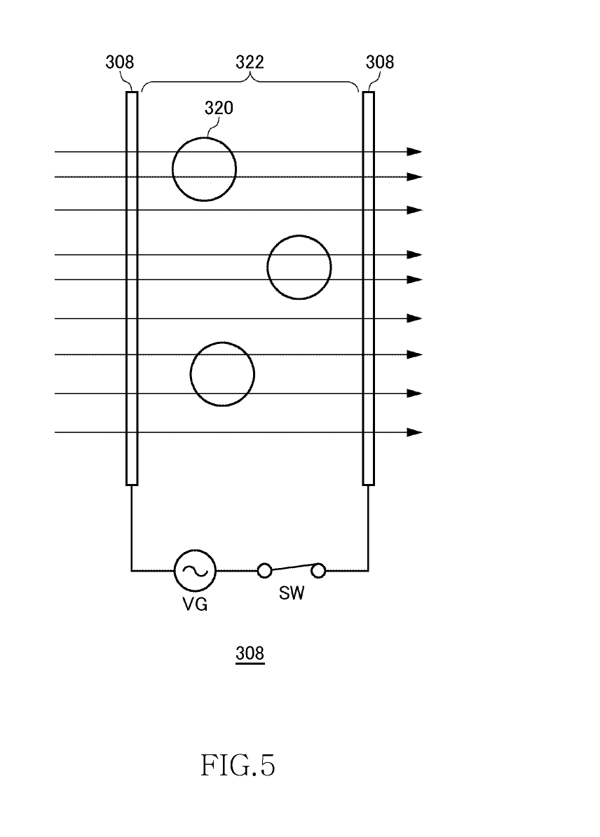

In this configuration, the power transmission control circuit 200 supplies AC power of the resonance frequency fr1 to the feeding coil L2. Then, the feeding coil L2 supplies the AC power of the resonance frequency fr1, and the receiving coil L3 receives the AC power, with the result that the AC power is supplied to the light control glass 308. Although details will be described using FIGS. 4 and 5, the light control glasses 308 has a property of becoming transparent when current is applied, while becoming opaque when current is not applied. Thus, the transparency of the light control glass 308 can be controlled by the power feeding function of the power transmission control circuit 200.

While bathing, the light control glass 308 may be made opaque for privacy protection. Instead, the light control glass 308 may be made transparent while bathing. For example, in the case of the bathroom 304 in a hotel, the light control glass 308 of the window may be made transparent for a user of the bathroom 304 to enjoy the scenery. In the case where the wireless power transmission system 100 is applied to the bathroom 304, the feeding coil L2 and receiving coil L3 need not be connected by wire. In particular, to be able to simplify a wiring configuration in a humid space like the bathroom 304 is a great advantage.

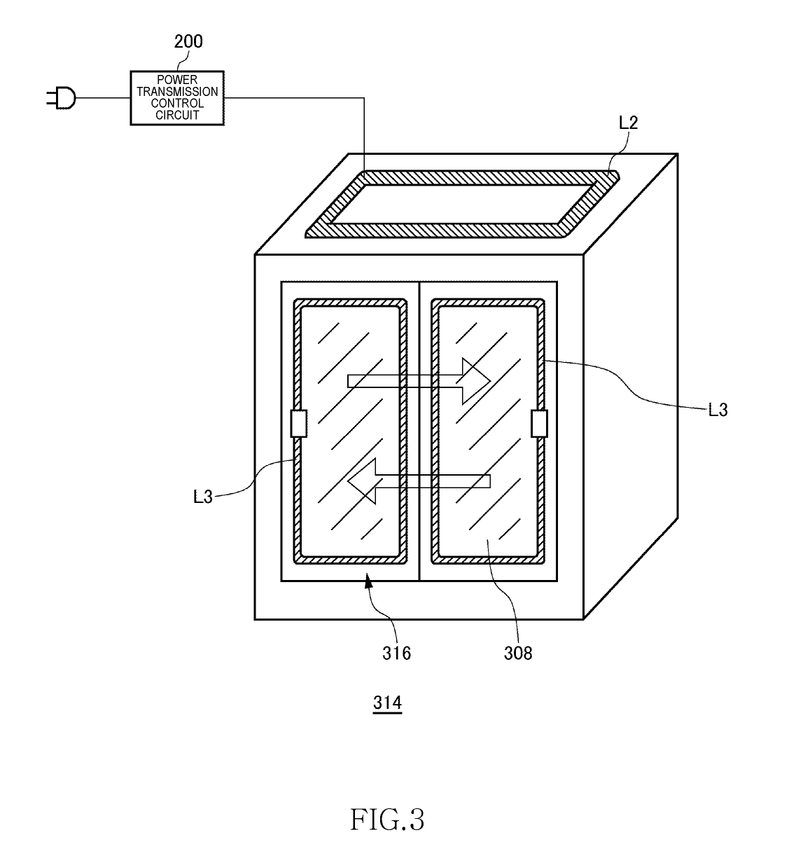

FIG. 3 is a view schematically illustrating a case where the wireless power transmission system 100 is applied to a showcase 314. The feeding coil L2 is installed on the top surface of the showcase 314. AC power is supplied to the feeding coil L2 at the resonance frequency fr1 from the power transmission control circuit 200.

The showcase 314 has a slide type window 316, and a light control glass 308 is fitted in the slide type window 316. Further, the receiving coil L3 and loading coil (not illustrated) are installed so as to surround the light control glass 308.

Also in this case, the feeding coil L2 and receiving coil L3 need not be connected by wire, allowing stable power feeding regardless of the installation position of the slide type window 316. For example, a configuration can be considered in which the light control glass 308 is made opaque when the slide type window 316 is opened wide and, otherwise, made transparent. When opening/closing of the slide type window 316 and a change in the transparency of the light control glass 308 are made to operate simultaneously with each other, it is possible to attract customers' attention to goods displayed in the showcase 314.

Next, a mechanism of the light control glass 308 will be described.

FIG. 4 is a view schematically illustrating a state of the light control glass 308 when current is not applied. The light control glass 308 has a structure in which a liquid crystal sheet 322 is sandwiched by two plate glasses 318. The liquid crystal molecules 320 contained in the liquid crystal sheet 322 have a polarity. The two plate glasses 318 are connected, via a switch SW, to a power supply VG which is an AC power supply. When the switch SW is OFF, the liquid crystal molecules 320 contained in the liquid crystal sheet 322 are oriented in random directions, so that the light control glass 308 scatters incident light. Thus, the light control glass 308 becomes opaque when current is not applied.

FIG. 5 is a view schematically illustrating a state of the light control glass 308 when current is applied. When the switch SW is ON, the liquid crystal molecules 320 are oriented in the same direction, so that the light control glass 308 transmits incident light. Thus, the light control glass 308 becomes transparent when current is applied.

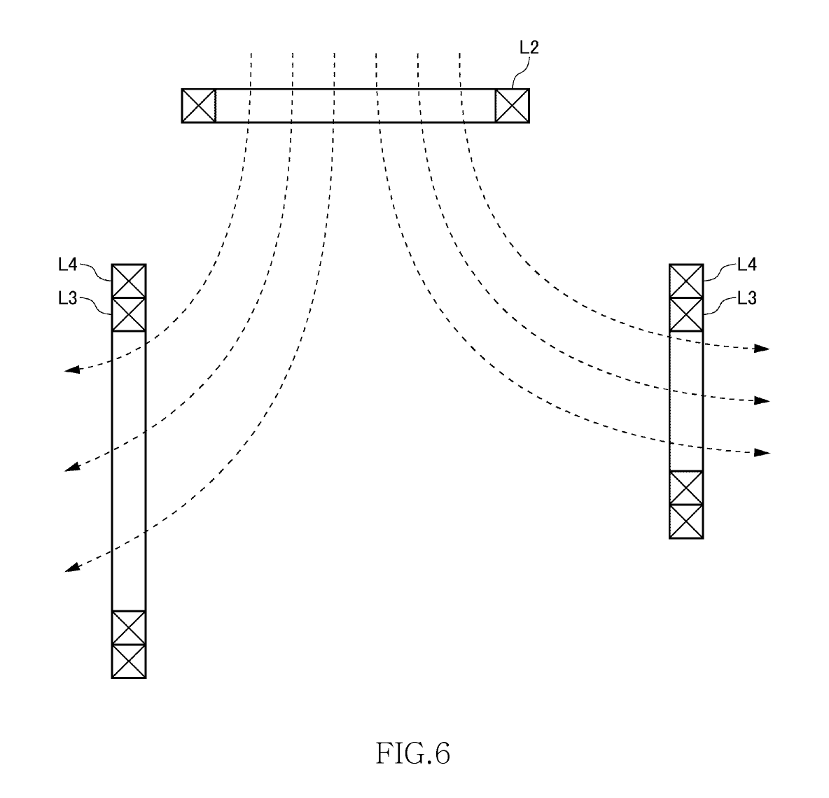

FIG. 6 is a view schematically illustrating a magnetic field generated between the feeding coil L2 and receiving coil L3. A loading coil L4 is installed so as to surround the outer periphery of the receiving coil L3. Thus, the receiving coil L3 and loading coil L4 are strongly magnetically coupled to each other. A part of a magnetic flux generated from the feeding coil L2 installed on the ceiling or the like of a building passes through the receiving coil L3 installed on the side wall or the like of the building. Although it is more effective to make the feeding coil L2 and receiving coil L3 face each other for enhancing power transmission efficiency, sufficient AC power can be supplied to the receiving coil L3 in the case of the magnetic field resonance type even in the configuration as illustrated in FIG. 6 where the feeding coil L2 and receiving coil L3 do not face each other. Thus, there is an advantage that the distance between the feeding coil L2 and receiving coil L3 and installation direction thereof can comparatively freely be set. Further, there is another advantage that AC power can be supplied from one feeding coil L2 to a plurality of receiving coils L3 at the same time.

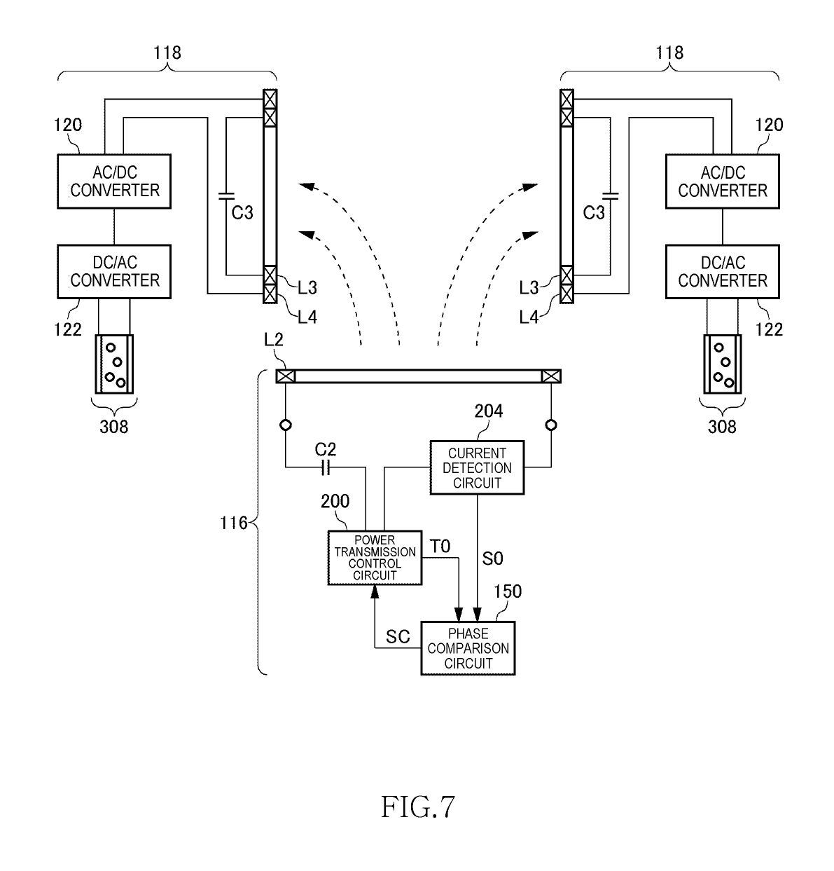

FIG. 7 is a system configuration view of the wireless power transmission system 100 according to the first embodiment. The power transmission control circuit 200 functions as an AC power supply and supplies AC power of a drive frequency fo to the feeding coil L2. A current detection circuit 204 measures the phase of the AC current flowing in the feeding coil L2. A phase comparison circuit 150 compares the phase of AC voltage generated by the power transmission control circuit 200 and current phase detected by the current detection circuit 204. When the drive frequency fo coincides with the resonance frequency fr1, the current phase and voltage phase coincide with each other. When the phase comparison circuit 150 detects a deviation (phase difference) between the current phase and voltage phase, the power transmission control circuit 200 adjusts the drive frequency fo so as to eliminate the deviation between the drive frequency fo and resonance frequency fr1. With the above configuration, the wireless power feeder 116 makes the drive frequency fo track the resonance frequency fr1.

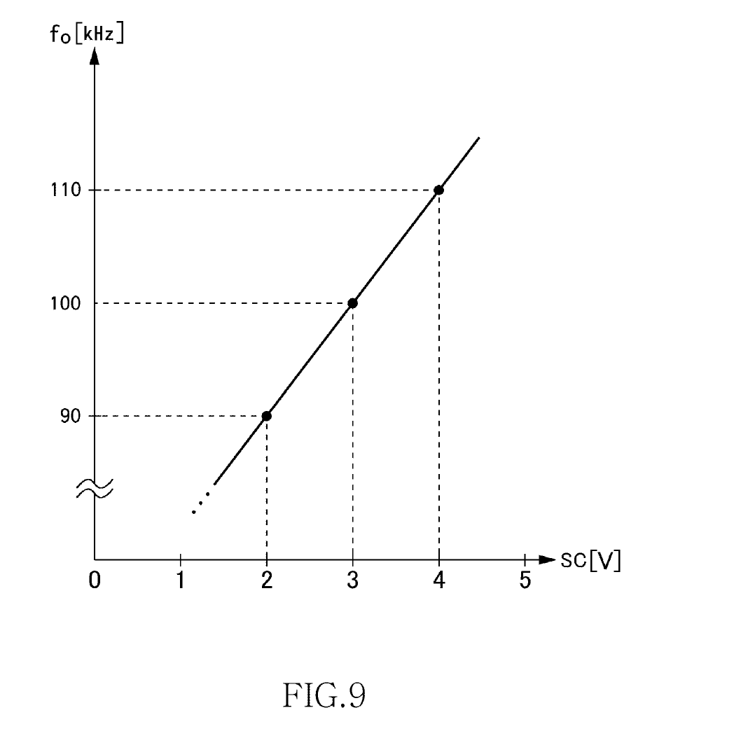

More concretely, a signal S0 representing a current waveform detected by the current detection circuit 204 is input to the phase comparison circuit 150. A signal T0 representing a voltage waveform of AC voltage generated by power transmission control circuit 200 is also input to the phase comparison circuit 150. The phase comparison circuit 150 outputs phase difference indicating voltage SC (DC voltage) representing the phase difference between the signal T0 and signal S0. Based on the phase difference indicating voltage SC, the power transmission control circuit 200 changes the drive frequency fo with reference to the graph of FIG. 9 to eliminate the phase difference. For example, mechanisms disclosed in U.S. patent application Ser. No. 13/096,559 and U.S. Patent Provisional Application No. 61/447,867 may be used to control the signal SC.

In the wireless power receiver 118, the receiving coil L3 and capacitor C3 constitute the power receiving LC resonance circuit 302.

The feeding coil L2 and receiving coil L3 need not have the same shape. When the feeding coil L2 generates an AC magnetic field at the resonance frequency fr1, the feeding coil L2 and receiving coil L3 are magnetic-field coupled, causing AC current to flow in the receiving coil L3. The receiving coil L3 and capacitor C3 also resonate by receiving the AC magnetic field generated by the feeding coil L2.

The receiving coil L3 and loading coil L4 face each other. The distance between the receiving coil L3 and loading coil L4 is zero. Thus, the receiving coil L3 and loading coil L4 are electromagnetically strongly coupled (coupling based on electromagnetic induction) to each other. When AC current flows in the receiving coil L3, an electromotive force occurs in the loading coil L4 to cause AC current to flow in the loading coil L4.

The AC power transmitted from the feeding coil L2 of the wireless power feeder 116 is received by the receiving coil L3 of the wireless power receiver 118. Then, the AC power is once converted into DC power by an AC/DC converter 120 and is then converted into AC power of a prescribed frequency of the light control glass 308 by a DC/AC converter 122. In this manner, AC power is supplied to the light control glass 308. When the AC power is supplied from the wireless power feeder 116 to wireless power receiver 118, the light control glass 308 becomes transparent. In particular, when the AC power is supplied to the receiving coil L3 at the resonance frequency fr1, the transparency of the light control glass 308 becomes maximum.

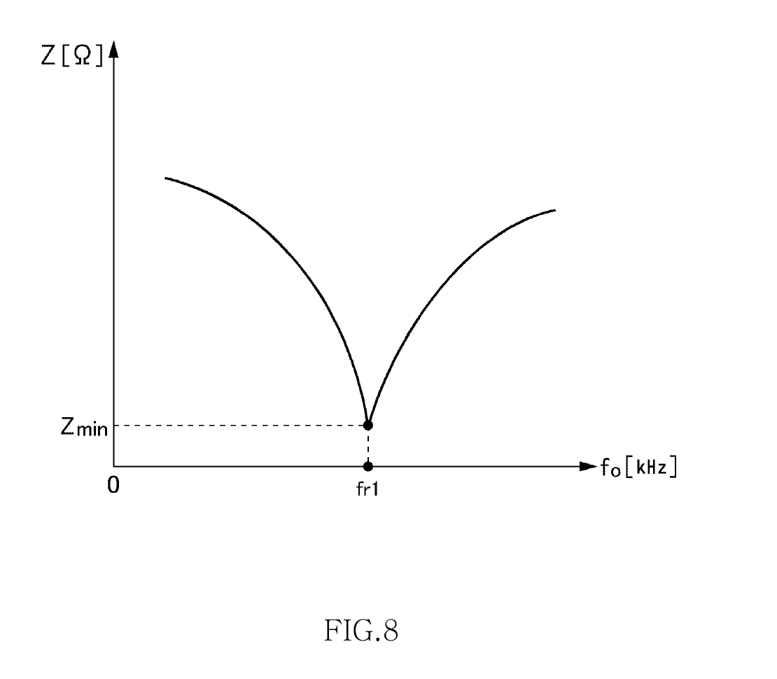

FIG. 8 is a graph illustrating a relationship between the impedance Z of the receiving LC resonance circuit 302 and drive frequency fo. The vertical axis represents the impedance Z of the receiving coil circuit 130 (a circuit in which the capacitor C3 and the receiving coil L3 are connected in series). The horizontal axis represents the drive frequency fo. The impedance Z is a minimum value Zmin at the resonance state. Although Zmin=0 at the resonance state is ideal, Zmin does not become zero in general since some resistance components are included in the receiving coil circuit 130.

When the drive frequency fo and resonance frequency fr1 coincide with each other, the impedance Z becomes minimum and the receiving coil circuit 130 is in a resonance state. When the drive frequency fo and resonance frequency fr1 deviate from each other, one of the capacitive reactance and inductive reactance prevails the other, so that the impedance Z is also increased.

When the drive frequency fo coincides with the resonance frequency fr1, AC current flows in the feeding coil L2 at the resonance frequency fr1, and the AC current also flows in the receiving coil circuit 130 at the resonance frequency fr1. The receiving coil L3 and capacitor C3 of the receiving coil circuit 130 resonate at the resonance frequency fr1, so that the power transmission efficiency from the feeding coil L2 to receiving coil L3 becomes maximum.

FIG. 9 is a graph illustrating the relationship between the phase difference indicating voltage SC and drive frequency fo. The relationship illustrated in FIG. 9 is set in the power transmission control circuit 200. The phase difference td between the current phase and voltage phase is proportional to a difference between the resonance frequency fr1 and drive frequency fo. Thus, the phase comparison circuit 150 determines the variation of the phase difference indicating voltage SC in accordance with the phase difference td and the power transmission control circuit 200 determines the drive frequency fo in accordance with the variation of the phase difference indicating voltage SC.

It assumed here that the resonance frequency fr1 is 100 kHz. In the initial state, the drive frequency fo is set to 100 kHz. At this time, the phase difference indicating voltage SC is initially set to 3.0 (V). It is assumed that the resonance frequency fr1 changes from 100 kHz to 90 kHz. Since the drive frequency fo (=100 kHz) is higher than the resonance frequency fr1 (=90 kHz) in this state, the phase difference td is less than 0. The phase difference td is proportional to the variation (−10 kHz) of the resonance frequency fr1. The phase detection circuit 114 determines the variation of the phase difference indicating voltage SC based on the phase difference td. In this example, the phase comparison circuit 150 sets the variation of the phase difference indicating voltage SC to −1 (V) and outputs new phase difference indicating voltage SC=2.0 (V). The power transmission control circuit 200 outputs the drive frequency fo=90 kHz corresponding to the phase difference indicating voltage SC=2.0 (V) according to the relationship represented by the graph of FIG. 9. With the above processing, it is possible to make the drive frequency fo automatically track a change of the resonance frequency fr1.

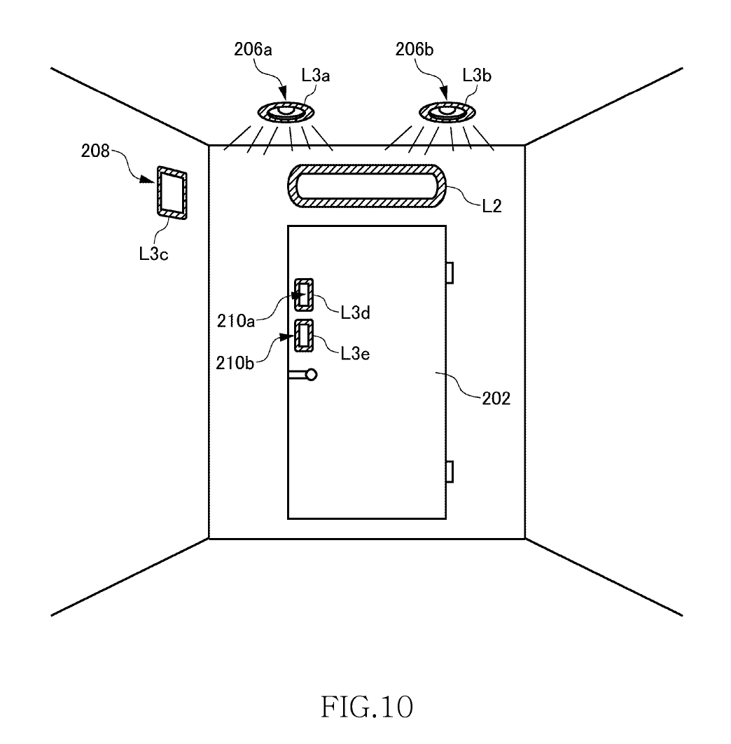

FIG. 10 is a view schematically illustrating a case where the wireless power transmission system 100 is applied to an electric lock 210, an interior light 206, and the like. The wireless power transmission system 100 can be applied to control of not only the light control glass 308 but also various electric products. In the case of a room illustrated in FIG. 10, the feeding coil L2 is installed in the inner wall of the room. The feeding coil L2 receives AC power from the power transmission control circuit 200 at the resonance frequency fr1.

A door 202 is formed in the inner wall, and the door 202 is locked by electric locks 210a and 210b. Further, an emergency light 208 is installed in the inner wall, and interior lights 206a and 206b are installed in the ceiling. Receiving coils L3a to L3e or loading coils (not illustrated) are set to the electric locks 210a, 210b, emergency light 208, and interior lights 206a, 206b, respectively.

AC power supplied from the feeding coil L2 causes the interior lights 206a, 206b, and emergency light 208 to turn ON. Further, the driving power of the electric locks 210a and 210b are supplied from the feeding coil L2. That is, AC power from one wireless power feeder 116 is supplied to a plurality of wireless power receivers 118. Thus, the AC power can collectively be supplied by wireless from one feeding coil L2 to a plurality of distributed electric products (interior lights 206, etc.), so that the number of wirings can be reduced.

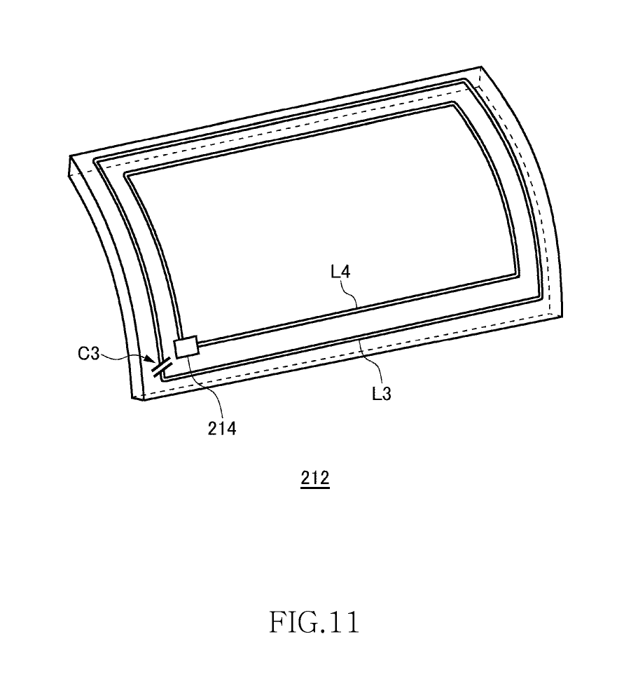

FIG. 11 is a view illustrating the outer appearance of a curved light control glass 212 including the wireless power receiver 118. The wireless power transmission system 100 can control the transparency of not only the flat-type light control glass 308 but also the curved light control glass 212. In FIG. 11, the receiving coil L3 and capacitor C3 are installed along the outer periphery of the light control glass 212. The receiving coil L3 may be incorporated in the light control glass 212 or may be printed on the surface thereof. The loading coil L4 is installed inside the receiving coil L3. A rectification circuit 214 is connected to the loading coil L4. Also in this case, by supplying AC power from the wireless power feeder 116 provided separately from the light control glass 212 to light control glass 212, the transparency of the light control glass 212 can be controlled.

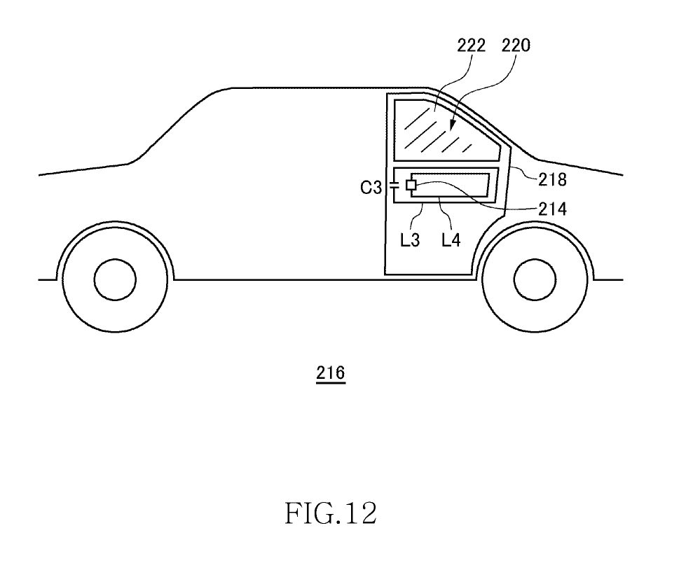

FIG. 12 is a view schematically illustrating a case where the wireless power transmission system 100 is applied to a vehicle 216. In the vehicle 216, a light control glass 222 is fit in a vehicle window 220 of a rear door 218. The wireless power receiver 118 including the receiving coil L3, loading circuit L4, rectification circuit 214, and the like is incorporated in the rear door 218. Further, the feeding coil L2 (not illustrated) is incorporated in the ceiling of the vehicle 216. With this configuration, the transparency of the light control glass 222 of the vehicle window 220 can be changed.

For example, when power feeding is stopped while the vehicle 216 is parked, the light control glass 222 becomes opaque, whereby the privacy of passengers can be protected. On the other hand, while the vehicle 216 is running or running at a speed higher than a predetermined threshold speed, there is a low risk that the vehicle interior can be seen by pedestrians. Thus, by performing wireless power feeding to make the light control glass 222 transparent, the passengers in the vehicle 216 can enjoy the scenery outside the vehicle.

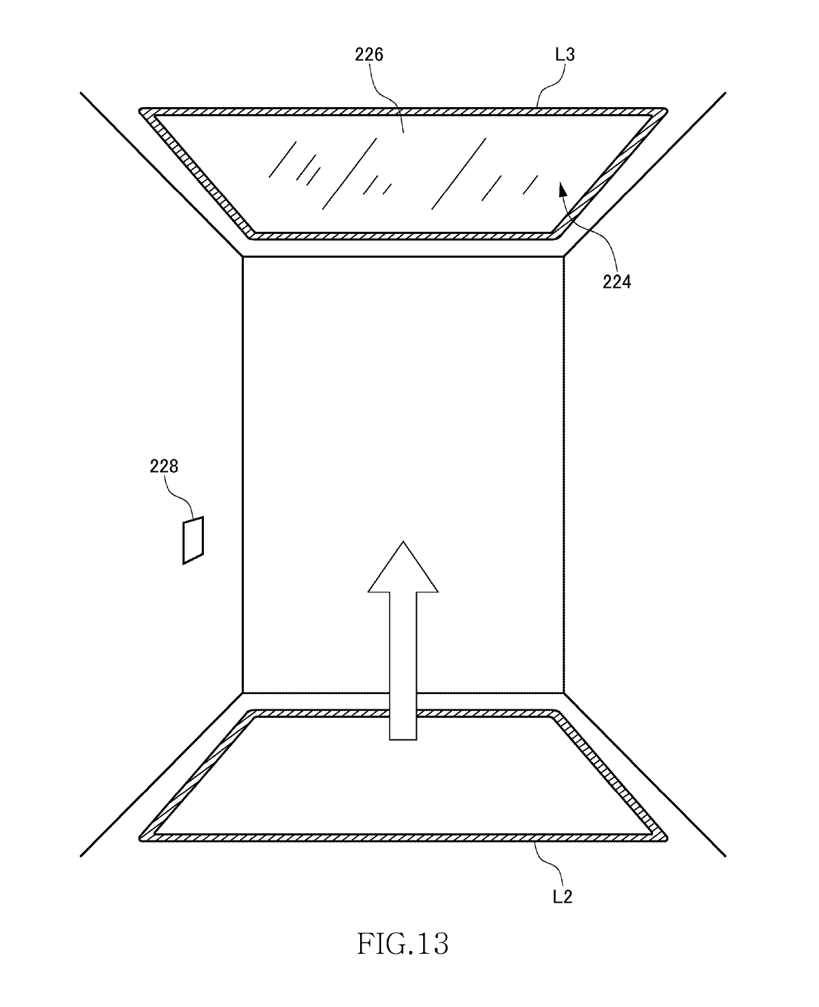

FIG. 13 is a view schematically illustrating a case where the transparency of a skylight 224 is controlled by the wireless power transmission system 100. The feeding coil L2 is incorporated in the floor of a room illustrated in FIG. 13. Further, the skylight 224 is formed using a light control glass 226, and the receiving coil L3 and loading coil L4 (not illustrated) are installed around the skylight 224. That is, the transparency of the light control glass 226 is controlled by a magnetic field generated from the feeding coil L2 incorporated in the floor.

A light sensor 228 detects the brightness of the room. When the brightness of the room has reached a predetermined threshold or more, the light sensor 228 transmits a light detection signal to the power transmission control circuit 200. The power transmission control circuit 200 is incorporated in the floor together with the feeding coil L2. When receiving the light detection signal, the power transmission control circuit 200 stops wireless power feeding. As a result, the light control glass 226 becomes opaque. That is, when the brightness of the room is sufficiently high, the outside light coming from the skylight 224 is controlled to be restricted. On the other hand, the brightness of the room is insufficient, the power transmission control circuit 200 resumes the wireless power feeding. Then, the light control glass 226 becomes transparent to make it easy for the outside light to be introduced into the room. According to such a control method, the light control glass 226 is made opaque when the direct sunlight is strong to allow the outside light to be restricted. In addition, temperature rise can be suppressed.

The transparency may be controlled not by the light but by humidity. For example, a hygrometer is set outside the room. When the humidity is low, that is, in the case of fine weather, the light control glass 226 is made transparent so as to aggressively introduce the outside light. On the other hand, the humidity is high, in particular, when the humidity is sufficiently high to generate mist, the power feeding is stopped so as to make the light control glass 226 opaque.

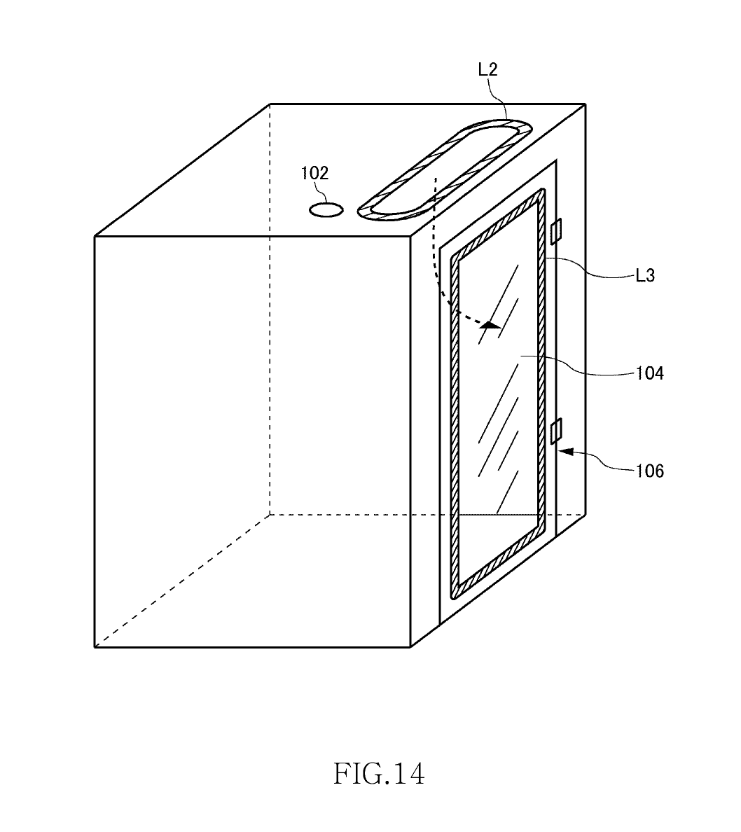

FIG. 14 is a view schematically illustrating a case where the transparency of a restroom door is controlled by the wireless power transmission system 100. A light control glass 104 is fitted in a door 106. The receiving coil L3 and loading coil L4 (not illustrated) are installed around the light control glass 104, and feeding coil L2 is installed in the ceiling of the restroom. When someone enters the restroom, a human sensing sensor 102 transmits a detection signal to the power transmission control circuit 200 (not illustrated) to thereby stop the power feeding from the feeding coil L2 to receiving coil L3. The power transmission control circuit 200 is installed in the ceiling portion or the like of the restroom.

That is, when the restroom is empty, the power is fed from the feeding coil L2 to receiving coil L3, whereby the light control glass 104 is made transparent. As a result, it is possible to confirm whether the restroom is empty or not from outside. When someone enters the restroom, the light control glass 104 is made opaque, whereby the privacy can be protected. A combination of the human sensing sensor 102 and wireless power transmission system 100 can be applied not only to the restroom, but also to an unmanned lending machine, an ATM (Automatic Teller Machine), a “Karaoke” box, a phone booth, and the like.

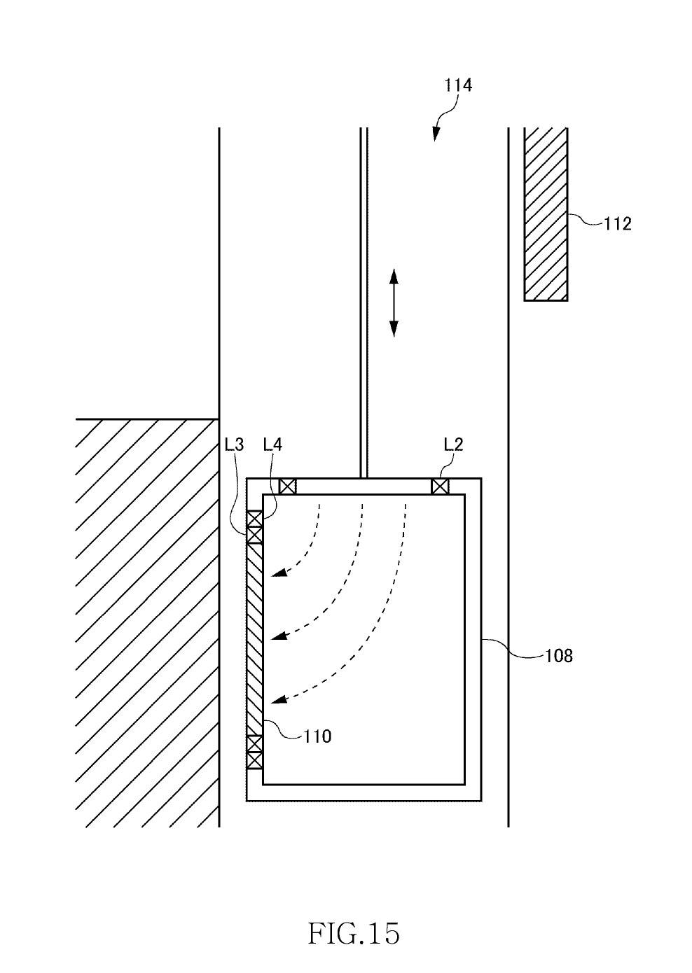

FIG. 15 is a view schematically illustrating the transparency of a window of an elevator cage 108 is controlled by the wireless power transmission system 100. The feeding coil L2 and not illustrated power transmission control circuit 200 are installed in the ceiling of the elevator cage 108. The receiving coil L3 and loading coil L4 are installed around the window of the elevator cage 108. The elevator window is formed using a light control glass 110, and power is always fed by wireless from the feeding coil L2 to receiving coil L3. However, the wireless power feeder 116 supplies AC power at a frequency band apart from the resonance frequency fr1, so that the light control glass 110 is opaque under a normal situation.

A magnetic body 112 is buried in a part of a hoistway (shaft) 114. In the example of FIG. 15, the magnetic body 112 is installed at a part above the ground. When the elevator cage 108 (feeding coil L2) approaches the magnetic body 112, the inductance of the feeding coil L2 changes. This is the same principle as a change in the inductance occurring when an iron-core is inserted into an air-core coil. Also in the case where the magnetic body 112 is installed not inside but outside the feeding coil L2, the magnetic characteristics of the feeding coil L2 can be changed. At this time, the feeding coil L2 supplies AC power at the resonance frequency fr1 to make the light control glass 110 transparent. In other words, parameters such as position, size, and magnetic permeability can be set appropriately so as to make the light control glass 110 transparent when the elevator cage 108 comes up the ground.

According to such a control method, a visual effect can be created in which the opaque window is made transparent when the elevator cage 108 comes up the ground to cause the scenery to burst into view. That is, the light control glass 110 is made opaque while the elevator cage 108 is located underground, while the light control glass 110 is made transparent while the elevator cage 108 is located above the ground where a nice view can be seen. Alternatively, in the case where the elevator cage 108 is installed at a location adjacent to an atrium space, the light control glass 110 may be made transparent when the elevator passes the atrium space. The opaque state and transparent state of the light control glass 110 need not be switched instantaneously. In the case where the elevator cage 108 is installed in a sightseeing tower, a configuration may be considered in which the transparency of the elevator cage 108 is made to increase gradually as the elevator cage 108 goes up. Concretely, a plurality of the light control glasses 110 are stacked and are made transparent sequentially one by one.

Alternatively, it is possible to control the transparency of the light control glass 110 not by means of the magnetic body 112 but by means of software or the like. For example, by changing the drive frequency fo in accordance with the position of the elevator cage 108, the transparency can be changed in accordance with the position of the elevator cage 108.

### Second Embodiment

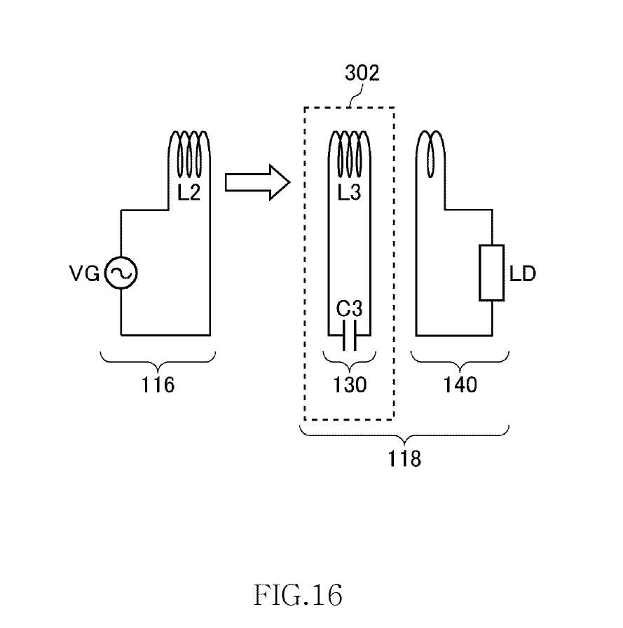

FIG. 16 is a view illustrating operation principle of the wireless power transmission system 100 according to a second embodiment. As in the case of the first embodiment, the wireless power transmission system 100 according to the second embodiment includes the wireless power feeder 116 and wireless power receiver 118. However, although the wireless power receiver 118 includes the power receiving LC resonance circuit 302, the wireless power feeder 116 does not include the power feeding LC resonance circuit 300. That is, the feeding coil L2 does not constitute a part of the LC resonance circuit. More specifically, the feeding coil L2 does not form any resonance circuit with other circuit elements included in the wireless power feeder 116. No capacitor is connected in series or in parallel to the feeding coil L2. Thus, the feeding coil L2 does not resonate in a frequency at which power transmission is performed.

The power feeding source VG supplies AC current of the resonance frequency fr1 to the feeding coil L2. The feeding coil L2 does not resonate but generates an AC magnetic field of the resonance frequency fr1. The receiving LC resonance circuit 302 resonates by receiving the AC magnetic field. As a result, large AC current flows in the power receiving LC resonance circuit 302. Studies conducted by the present inventor have revealed that formation of the LC resonance circuit is not essential in the wireless power feeder 116. The feeding coil L2 does not constitute a part of the power feeding LC resonance circuit, so that the wireless power feeder 116 does not resonate at the resonance frequency fr1. It has been generally believed that, in the wireless power feeding of a magnetic field resonance type, making resonance circuits which are formed on both the power feeding side and power receiving side resonate at the same resonance frequency fr1 (=fr0) allows power feeding of large power. However, it is found that even in the case where the wireless power feeder 116 does not contain the power feeding LC resonance circuit 300, if the wireless power receiver 118 includes the power receiving LC resonance circuit 302, the wireless power feeding of a magnetic field resonance type can be achieved.

Even when the feeding coil L2 and receiving coil L3 are magnetic-field-coupled to each other, a new resonance circuit (new resonance circuit formed by coupling of resonance circuits) is not formed due to absence of the capacitor C2. In this case, the stronger the magnetic field coupling between the feeding coil L2 and receiving coil L3, the greater the influence exerted on the resonance frequency of the power receiving LC resonance circuit 302. By supplying AC current of this resonance frequency, that is, a frequency near the resonance frequency fr1 to the feeding coil L2, the wireless power feeding of a magnetic field resonance type can be achieved. In this configuration, the capacitor C2 need not be provided, which is advantageous in terms of size and cost.

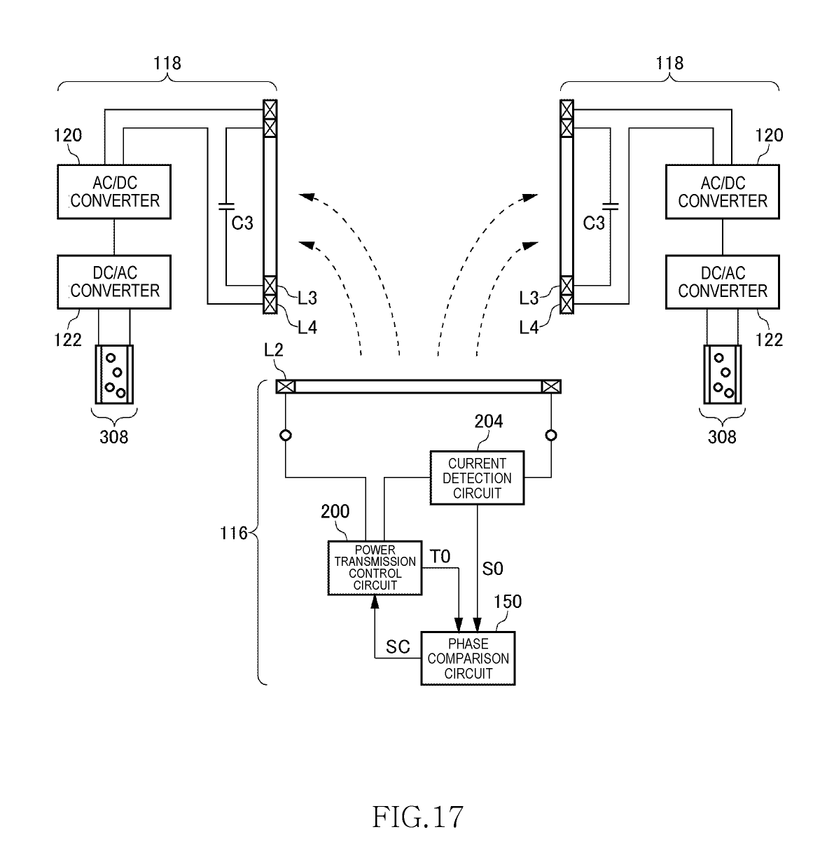

FIG. 17 is a system configuration view of the wireless power transmission system 100 according to the second embodiment. In the wireless power transmission system 100 of the second embodiment, the capacitor C2 is omitted. Other points are the same as the first embodiment.

The wireless power transmission system 100 according to the present embodiments has been described above. A use of the wireless power transmission system 100 to control the transparency of the light control glass allows simplification of the electric wiring. In particular, it makes easier to layout the feeding coil L2 and receiving coil L3. Further, in this wireless power transmission system 100, AC power can collectively be fed from one feeding coil L2 to a plurality of receiving coils L3. The wireless power transmission system 100 can be applied to power supply not only for the light control glass but also for various interior products such as an electric lock and an interior light.

The present invention has been described based on the above embodiments. It should be understood by those skilled in the art that the above embodiments are merely exemplary of the invention, various modifications and changes may be made within the scope of the claims of the present invention, and all such variations may be included within the scope of the claims of the present invention. Thus, the descriptions and drawings in this specification should be considered as not restrictive but illustrative.

The “AC power” used in the wireless power transmission system 100 may be transmitted not only as an energy but also as a signal. Even in the case where an analog signal or digital signal is fed by wireless, the wireless power feeding method of the present invention may be used.

A system combining a solar battery and a light control glass is assumed as a modification. In this system, the solar battery serves a part of the wireless power feeder 116, and light control glass serves a part of the wireless power receiver 118. The solar battery incorporates the feeding coil L2, and receiving coil L3 and loading circuit L4 are installed in the light control glass. The solar battery supplies power to the light control glass by means of the feeding coil L2. The light control glass is installed so as to cover the surface of the solar battery.

The power transmission control circuit 200 detects the power generation of the solar battery and controls stop/resume of power feeding. When the power generation per unit time is equal to or higher than a threshold value, in other words, when the power generation is high, power is fed from the solar battery to light control glass. At this time, the light control glass becomes transparent, that is, the light transmissibility of the light control glass is increased, so that the solar battery can generate power effectively. On the other hand, when the power generation per unit time is lower than a threshold value, the power feeding to the light control glass is stopped. For example, in a cloudy day, the power feeding to the light control glass is not performed. In this case, the panel surface of the solar battery is hidden by the opaque light control glass.

According to such a control method, the following advantage can be obtained. That is, when the power generation efficiency is high (e.g., in a clear day), the light control glass is made transparent by abundantly available electric energy to increase the power generation efficiency; while when the power generation efficiency is low (e.g., in poor weather conditions), the panel surface of the solar battery can be hidden by the opaque light control glass. As a result, both an increase in the power generation efficiency and landscape preservation can easily be achieved simultaneously. In the future, as the solar battery has become more popular, preservation of the appearance of the streets may become the main issue.

What is claimed is:

1. A wireless power transmission system for feeding power by wireless from a feeding coil to a receiving coil using a magnetic field resonance phenomenon between the feeding coil and receiving coil, the system comprising:
the feeding coil;
the receiving coil;
a power transmission control circuit that supplies AC power to the feeding coil so as to make the feeding coil feed the AC power to the receiving coil;
a loading coil that is magnetically coupled to the receiving coil to receive the AC power from the receiving coil; and
a light control glass that receives the AC power from the loading coil,
the transparency of the light control glass being changed by the AC power received by the loading coil.

2. The wireless power transmission system according to claim 1, wherein
both the feeding coil and receiving coil are installed in the inner wall of a building.

3. The wireless power transmission system according to claim 2, wherein
the feeding coil is installed in the ceiling of the building, and the receiving coil is installed in the side wall of the building.

4. The wireless power transmission system according to claim 1, wherein
the receiving coil and loading coil are installed so as to surround the light control glass.

5. The wireless power transmission system according to claim 1, wherein
the feeding coil is installed in the inner wall of a vehicle, and
the light control glass is fit in a vehicle window.

6. The wireless power transmission system according to claim 5, wherein
the receiving coil and loading coil are installed in the window frame of the vehicle.

7. The wireless power transmission system according to claim 1, further comprising a light sensor for measuring the brightness of a room, wherein
the power transmission control circuit controls the supply of AC power to the feeding coil according to the light amount detected by the light sensor.

8. The wireless power transmission system according to claim 1, further comprising a human sensing sensor, wherein
the power transmission control circuit stops supplying AC power to the feeding coil when the human sensing sensor reacts to make the light control glass opaque.

9. The wireless power transmission system according to claim 1, wherein
a plurality of the receiving coils are provided corresponding to a plurality of light control glasses, respectively, and power is collectively fed from the one feeding coil to the plurality of receiving coils.

10. The wireless power transmission system according to claim 1, wherein
the light control glass is installed as an outer wall of an elevator.

11. The wireless power transmission system according to claim 10, wherein
the inductance of the feeding coil is temporarily changed by a magnetic body installed in a part of a hoistway of the elevator.

12. A wireless power transmission system for feeding power by wireless from a feeding coil to a receiving coil using a magnetic field resonance phenomenon between the feeding coil and receiving coil, the system comprising:
the feeding coil;
the receiving coil;
a power transmission control circuit that supplies AC power to the feeding coil so as to make the feeding coil feed the AC power to the receiving coil;
a loading coil that is magnetically coupled to the receiving coil to receive the AC power from the receiving coil; and
an electric lock that receives the AC power from the loading coil,
the electric lock being activated or released by the AC power received by the loading coil.

13. A wireless power transmission system for feeding power by wireless from a feeding coil to a receiving coil using a magnetic field resonance phenomenon between the feeding coil and receiving coil, the system comprising:
the feeding coil installed as a part of a building;
the receiving coil installed as a part of the building;
a power transmission control circuit that supplies AC power to the feeding coil so as to make the feeding coil feed the AC power to the receiving coil;
a loading coil that is magnetically coupled to the receiving coil to receive the AC power from the receiving coil; and
a lighting apparatus that receives the AC power from the loading coil,
the lighting apparatus being turned ON by the AC power received by the loading coil.
